(19) United States
(12) Patent Application Publication
(10) Pub. No.: US 2010/0075124 A1
(43) Pub. Date: Mar. 25, 2010

(54) APPARATUS HAVING PLANARIZED SUBSTRATE AND METHOD OF MANUFACTURING THE SAME

(76) Inventors: Jong-Seong Kim, Seoul (KR); Min-Ho Yoon, Seoul (KR); Woo-Jae Lee, Yongin-si (KR)

Correspondence Address: Haynes and Boone, LLP;IP Section, 2323 Victory Avenue, SUITE 700, Dallas, TX, 75219, US

(21) Appl. No.: 12/399,800

(22) Filed: Mar. 6, 2009

(30) Foreign Application Priority Data
Sep. 25, 2008 (KR) 2008-0094086

(51) Int. Cl. B32B 27/06

(52) U.S. Cl. 428/220; 427/58; 156/182

(57) ABSTRACT

Disclosed are an apparatus having a planarized substrate and a method of manufacturing the same. A coating layer is formed on a concave-convex substrate used for the apparatus and cured, thereby planarizing the concave-convex substrate.

### CROSS-REFERENCE TO RELATED APPLICATION

This application relies for priority upon Korean Patent Application No. 2008-94086 filed on Sep. 24, 2008, the contents of which are herein incorporated by reference in their entirety.

### BACKGROUND OF THE INVENTION

1. Field of the Invention

The present invention relates to an apparatus and a method of manufacturing the same. More particularly, the present invention relates to an apparatus and a method of manufacturing the same using a substrate planarized by a coating layer.

2. Description of the Related Art

Since demands for various display apparatuses have been increased with the development of the information society, research on flat panel displays such as LCDs (liquid crystal displays) and PDPs (plasma display panels) has been actively performed. Among them, LCDs have been currently spotlighted due to mass production, simple driving scheme, and high quality images thereof.

The LCD includes a liquid crystal layer interposed between two transparent substrates, and drives the liquid crystal layer to adjust light transmittance in each pixel, thereby displaying a desired image.

In addition, although the LCD is a flat panel display, application fields thereof final 1 are limited due to lack of flexibility. In this regard, demands for a flexible LCD applicable to various fields have also been increased.

However, when the LCD is manufactured using a typical plastic substrate, substrate selection becomes an important factor for all processes including a thin film transistor process, a color filter process, a liquid crystal forming process, and a module process. Accordingly, the substrate must be properly selected based on characteristics of the substrate by taking process conditions of subsequent processes into consideration.

Flatness of a substrate is one of the characteristics of the substrate for the substrate selection. If the substrate is lacking flatness, the substrate has a concave-convex shape, so that a great amount of defects may be caused when performing the thin film transistor process or forming a color filter.

### SUMMARY OF THE INVENTION

Therefore, the present invention provides a method of manufacturing an apparatus through an easy and simple manner in order to overcome step differences of a substrate.

The present invention also provides an apparatus such as a display apparatus capable of minimizing defects caused by the step difference of the substrate in subsequent processes by overcoming the step difference of the substrate.

In one aspect of the present invention, a method of manufacturing the apparatus is performed as follows. A substrate is prepared. A coating layer comprising polyamic acid co-polymer is formed on the substrate to planarize the substrate. A plurality of thin films are formed on the coating layer.

Monomers of the polyamic acid co-polymer comprises monomers represented by the following formulae 1 and 2, wherein R₁ represents carbon or tetracarboxylic dianhydride, R₂ represents C₁-C₂₀ alkane or diamine, and R₃ represents C₁-C₂₀ alkane or diol.

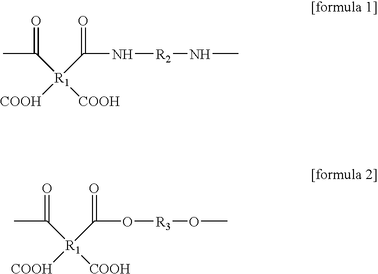

The substrate comprises a front surface, a rear surface facing the front surface, and a side surface connecting the front surface to the rear surface. The coating layer is formed by coating a coating material on at least one of the front surface and the rear surface of the substrate, and curing the coating material.

The coating material comprises a composition of about 7.5 wt % to about 9 wt % of polyesterpolyamic acid prepolymer, about 5 wt % to about 18 wt % of epoxy polymer, about 1 wt % to about 2 wt % of an epoxy curing agent, about 0.1 wt % of a silane cross-linking agent, and about 70 wt % or more of methyl-3-methoxypropionate.

The coating material is cured at a temperature less than the glass transition temperature of the substrate, for example, at a temperature of about 180° C. or less, for about 30 minutes to about three hours. In one embodiment, the coating layer has a thickness equal to or greater than about 1.4 μm.

The apparatus may be a display apparatus such as liquid crystal display. The method of manufacturing the liquid crystal display apparatus further comprises preparing a counter substrate to face the substrate and forming a liquid crystal layer between the substrate and the counter substrate.

In addition, the display apparatus may be an electroluminescent device having an organic light emitting layer, an electrophoresis display including electric-charged pigments. Moreover, the apparatus may be a solar cell other than the display apparatuses.

As described above, the present invention suggests a scheme of easily planarizing a concave-convex substrate through a simple process under a relatively low temperature, and a high-quality display apparatus capable of remarkably minimizing defects caused by step difference(s) by manufacturing the display apparatus after the concave-convex substrate is planarized through the above scheme.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic plan view showing a portion of an LCD according to one embodiment of the present invention;

FIG. 2 is a sectional view taken along line II-II′ of a substrate shown in FIG. 1;

FIG. 3 is a graph showing thickness deviation in a portion of a fiber reinforced plastic substrate on the assumption that an average thickness thereof is 0;

FIG. 4 is a graph showing thickness deviation in another portion of a fiber reinforced plastic substrate on the assumption that an average thickness thereof is 0;

FIGS. 5A to 5F are sectional views sequentially showing a method of manufacturing a display apparatus according to one embodiment;

FIGS. 6A to 6C are graphs in three positions of a surface of the fiber reinforced plastic substrate before a coating layer is formed; and

FIGS. 7A to 7C are graphs in three positions of the surface of the fiber reinforced plastic substrate after a coating layer is formed.

### DESCRIPTION OF THE EMBODIMENTS

Hereinafter, an apparatus according to one embodiment of the present invention will be explained in detail with reference to the accompanying drawings. It should be understood that the present invention is not limited to the appended drawings but includes all modifications, equivalents and alternatives within the sprit and scope of the present invention as defined in the following claims. The drawings can be simplified or magnified to clearly express a plurality of layers and regions. In the drawings, the same reference numerals are used to designate the same elements.

As used herein, the expression, “one film (layer) is formed (disposed) ‘on’ another film (layer) includes not only a case wherein the two films (layers) are in contact with each other but also a case wherein an additional film (layer) is present between the two films (layers).

The present invention suggests an apparatus including a substrate having step difference(s) caused by concave-convex surfaces and a coating layer formed on the substrate having the concave-convex surfaces to planarize the substrate, and a method of manufacturing the same.

Although an LCD (Liquid Crystal Display) including the substrate may be employed as an example of the apparatus according to the present embodiment, the present invention is not limited thereto. Accordingly, the present invention is applicable to display apparatuses (e.g., organic light emitting diode display or plasma display panel) and other various apparatuses such as a solar cell that can be manufactured with the planarized substrate.

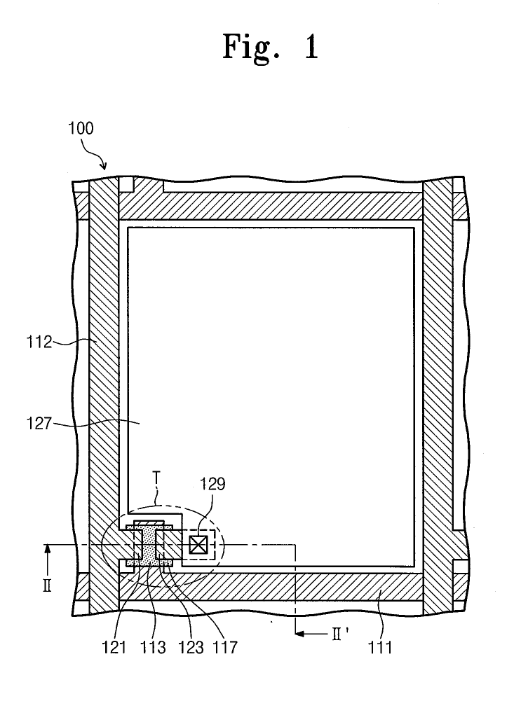

FIG. 1 is a schematic plan view showing a portion of an LCD 100 according to one embodiment of the present invention.

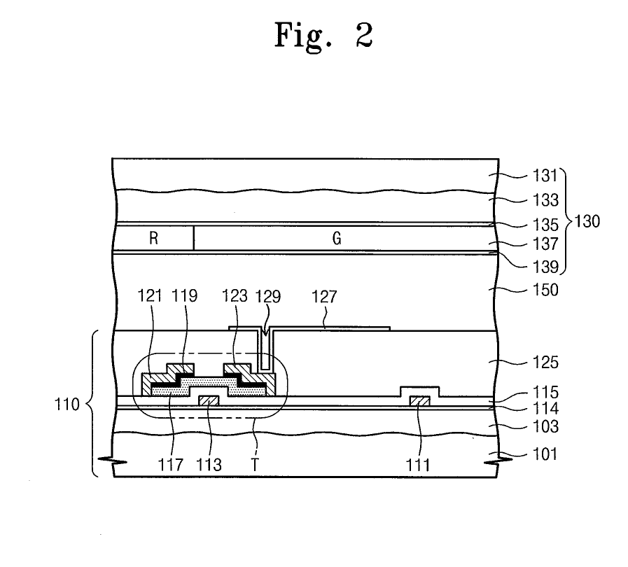

FIG. 2 is a schematic sectional view taken along line II-II′ of a substrate shown in FIG. 1, showing the LCD 100 according to one embodiment of the present invention.

The LCD 100 includes a plurality of pixels. Pixels are defined by a plurality of gate lines 111 and a plurality of data lines 112, which cross each other. One pixel is representatively shown for the purpose of explanation.

As shown in FIGS. 1 and 2, the LCD 100 according to one embodiment of the present invention includes a first substrate 110, a second substrate 130 facing the first substrate 110, and a liquid crystal layer 150 formed between the first substrate 110 and the second substrate 130.

The first substrate 110 includes a first insulating substrate 101. The first insulating substrate has a surface with concave-convexes thereon, and a first coating layer 103 is formed on the first insulating layer 101 to planarize the surface with concave-convex surface portions. The first substrate 110 having the surface with concave-convex surface portions may be a flexible substrate (e.g., a fiber reinforced plastic substrate, a metal substrate, or a sodalime substrate). According to the present embodiment, the fiber reinforced plastic substrate will be representatively described below.

A first blocking layer 114 is formed on the first coating layer 103 to block impurities, for example, gas or foreign matters, from being diffused from first coating layer 103 or the exterior into a thin film transistor T, which is later formed on an upper portion of the first substrate 110.

The first blocking layer 114 may be a single layer of silicon nitride (SiNx) or silicon oxide (SiO₂) or a double layer of silicon nitride (SiNx) or silicon oxide (SiO₂) and a transparent acrylate polymer layer.

The gate line 111 and the data line 112 are arranged in longitudinal and traverse directions on the first blocking layer 114 to define a pixel area. The thin film transistor T is formed at an intersection of the gate line 111 and the data line 112, and a pixel electrode 127 is connected to the thin film transistor T in the pixel area to generate an electric field together with a common electrode 139 of the second substrate 130, thereby driving liquid crystal.

The thin film transistor T includes a gate electrode 113 connected to the gate line 111, a source electrode 121 connected to the data line 112, and a drain electrode 123 connected to the pixel electrode 127. In addition, the thin film transistor T includes a gate insulating layer 115 to insulate the gate electrode 113 from the source and drain electrodes 121 and 123, an active layer 117 and an ohmic contact layer 119 forming a conduction channel between the source electrode 121 and the drain electrode 123 when a gate voltage is applied to the gate electrode 113.

A protective layer 125 is formed on the thin film transistor T, and a contact hole 129 is formed in the protective layer 125 to expose a portion of the drain electrode 123 such that the pixel electrode 127 is connected to the drain electrode 123 through the contact hole 129.

The second substrate 130, which is a counter substrate to the first substrate 110, is provided in opposition to the first substrate 110. The second substrate 130 includes the second insulating substrate 131. The second insulating substrate has a surface with concave-convex surface portions. A second coating layer 133 is formed on the second insulating substrate 131 to planarize the surface with concave-convex surface portions.

A color filter 137 is formed on the second coating layer 133 to express colors of pixels. A second blocking layer 135 is formed between the color filter 137 and the second coating layer 133 to block impurities, for example, gas or foreign matters from being diffused into the color filter 137 from the second coating layer 133 or an exterior.

Similar to the first blocking layer 114, the second blocking layer 135 may be a single layer of silicon nitride (SiNx) or silicon oxide (SiO2) or a double layer of silicon nitride (SiNx) or silicon oxide (SiO2) and a transparent acrylate polymer layer. The common electrode 139 is formed on the color filter 137 to form an electric field together with the pixel electrode 127.

The LCD 100 having the above structure is driven by supplying a common voltage, which is a reference voltage used to drive liquid crystal, to the common electrode 139, and applying a pixel signal from the data line 112 to the pixel electrode 127 in response to a scan signal from the gate line 111 of the thin film transistor T. Accordingly, an electric field is generated between the common electrode 139 and the pixel electrode 127, and liquid crystal molecules are tilted by the electric field to adjust light transmittance, thereby displaying an image.

According to the present embodiment, both of the first and second substrates 110 and 130 include the first and second insulating substrates 101 and 131 (first and second fiber reinforced plastic substrates) having concave-convex surfaces. Although not additionally described, according to another embodiment, only one of the first and second substrates 110 and 130 may include a fiber reinforced plastic substrate if necessary. For example, the first substrate 110 may be a fiber reinforced plastic substrate, and the second substrate 130 may be a typical glass substrate. If necessary, the second substrate 130 may be a different type of a plastic substrate.

Each of the first and second substrates 110 and 130 have a plate shape with a front surface and a rear surface facing the front surface. A side surface is interposed between the front surface and the rear surface to connect the two surfaces to each other. The front surface or the rear surface has a rectangular shape, and the two surfaces are provided at edges thereof with the side surface perpendicular to the front and rear surfaces. The height of the side surface is a thickness of the first substrate 110 or the second substrate 130.

According to one embodiment, a fiber reinforced plastic substrate may be used as a flexible substrate. The fiber reinforced plastic substrate may include glass fiber cloth. The glass fiber cloth is fabricated by twisting several strands of glass filaments to make yarn and by weaving the yarn. A scheme of weaving the yarn is not limited, but the present invention includes schemes of plain weaves, twill weaves, satin weaves, lene plain, and mock leno.

Since the fiber reinforced plastic substrate has a low coefficient of thermal expansion and low birefringence compared with that of a typical plastic substrate, the fiber reinforced plastic substrate is suitable for the display apparatus. If a coefficient of thermal expansion is large, a substrate is excessively compressed/expanded during the manufacturing process, so that process problems such as misalignment or curving may occur. However, since the fiber reinforced plastic substrate has low coefficient of thermal expansion, mis-alignment or curving defects can be minimized. In addition, since the fiber reinforced plastic substrate has low birefringence, light leakage caused by great birefringence may not occur. Accordingly, display quality is raised in the display apparatus employing the fiber reinforced plastic substrate. Therefore, fiber reinforced plastic fabricated by impregnating glass fiber or yarn or cloth including the glass fiber into organic resin (e.g., epoxy resin) is used as a material of a substrate.

However, although the fiber reinforced plastic substrate has superior properties as described above, the fiber reinforced plastic substrate is fabricated by impregnating glass fiber, yarn including the glass fiber, or glass fiber cloth into organic resin, so that step differences may occur due to roughness of the glass fiber or a mass of the yarn. Roughness caused by the glass fiber is shown in a narrow area of the fiber reinforced plastic substrate, and roughness caused by the non-uniformity of the yarn or the glass fiber cloth is shown in a wider area of the fiber reinforced plastic substrate.

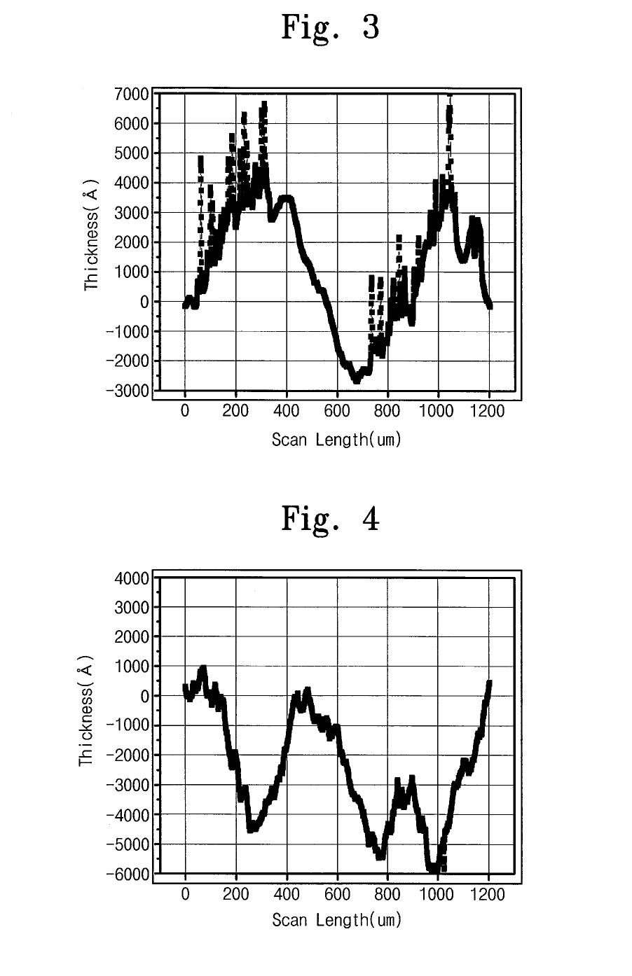

FIGS. 3 and 4 are graphs showing a surficial height in portions of a fiber reinforced plastic substrate on the assumption that an average surficial height of the fiber reinforced plastic substrate is 0. In other words, a portion of the fiber reinforced plastic substrate having a surficial height higher than the average surficial height is marked as a positive (+) value, and a portion of the fiber reinforced plastic substrate having a surficial height lower than the average surficial height is marked as a negative (−) value. If a thickness is represented as −3000 Å it means that the fiber reinforced plastic substrate is recessed by about 3000 Å from the average surficial height. As a peak-to-peak difference of a curve of the graph is increased, surficial roughness of the fiber reinforced plastic substrate is increased.

As shown in FIGS. 3 and 4, great surficial roughness appears in a narrow area of the fiber reinforced plastic substrate. In a wide area of the fiber reinforced plastic substrate, difference between a recessed portion and a protrusion portion corresponds to about 7000 Å to about 8000 Å, so that roughness deviation or thickness difference exists.

In addition to the fiber reinforced plastic substrate, a metal substrate or a low-price sodalime substrate represents high step difference on the surface thereof as compared with a substrate based on borosilicate aluminum.

The step difference formed by the thickness difference causes failures in final image display or characteristics of a thin film transistor after subsequent processing to form devices on the substrate.

Therefore, the present invention is characterized in that the step difference of the fiber reinforced plastic substrate is planarized by covering the surface thereof using an organic coating layer under a glass transition temperature (Tg) or less of fiber reinforced plastic. In this case, the organic coating layer is formed with a thickness thicker than the step difference of the fiber reinforced plastic substrate such that thickness deviation thereof can be minimized. In one example, the thickness of the organic coating layer is preferably about 1.4 μm or more.

The present invention is characterized in that a coating layer is formed with a thickness sufficient to planarize the step difference of the fiber reinforced plastic substrate. The coating layer may have a thickness equal to or greater than about 1.4 μm in one example. If the thickness of the coating layer is smaller than the range, the coating layer cannot sufficiently offset the step difference of the fiber reinforced plastic substrate. The coating layer may include thermosetting resin. According to one embodiment of the present invention, the coating layer basically includes polyesterpolyamic acid co-polymer.

Monomers of the polyesterpolyamic acid co-polymer are shown in formulae 1 and 2. The monomers of formulae 1 and 2 are co-polymerized, resulting in alternating co-polymer, periodic co-polymer, random co-polymer or block co-polymer.

The coating layer may be formed by polymerizing the monomers, or may be formed by polymerizing a small molecular co-polymer, which is served as prepolymer, through temperature raising, so as to form polyesterpolyamic acid co-polymer.

In this case, R₁ represents carbon (C) or tetracarboxylic dianhydride, R₂ represents C₁-C₂₀ alkane or diamine, and R₃ represents C₁-C₂₀ alkane or diol.

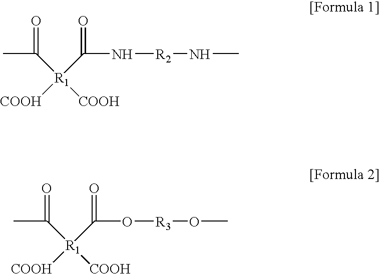

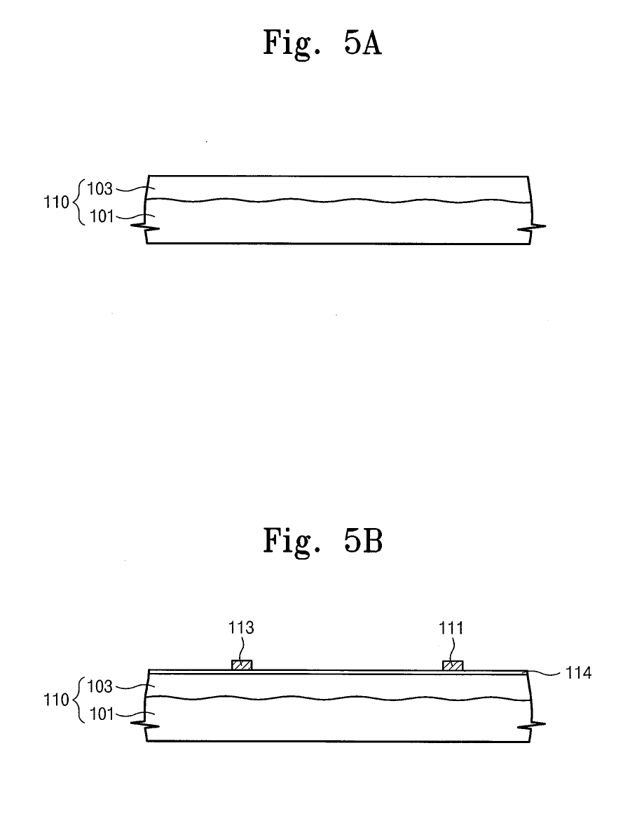

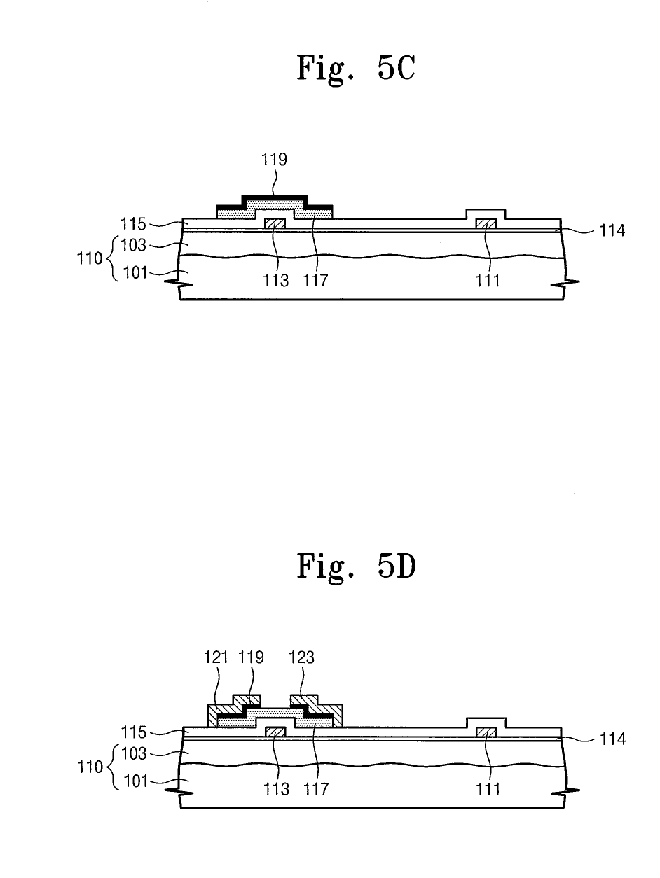

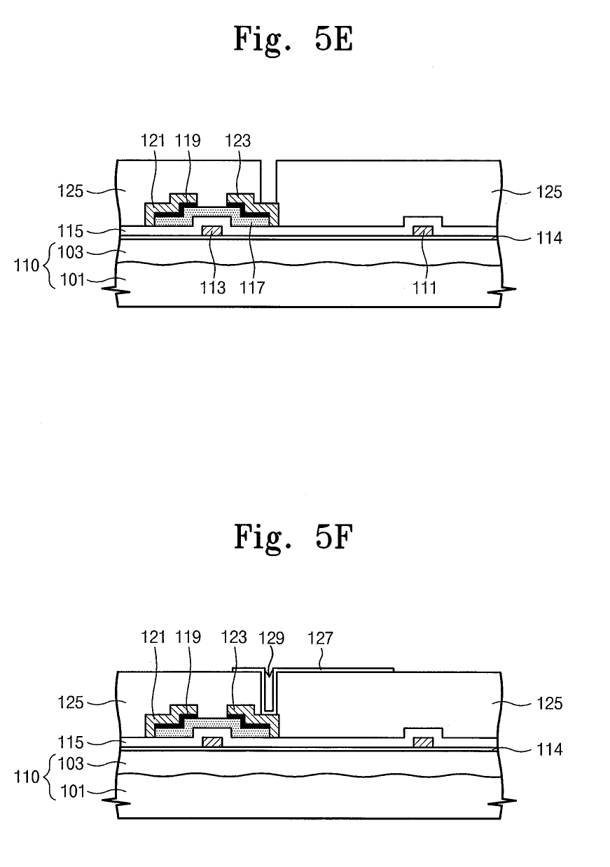

Hereinafter, a method of manufacturing the LCD 100 according to one embodiment of the present invention will be described with reference to FIGS. 5A to 5F. Although a fiber reinforced plastic substrate serves as the first insulating substrate 101 having concave-convexes according to the present embodiment, the present invention is not limited thereto.

In addition, although the LCD 100 having the liquid crystal layer 150 interposed between the first and second substrates 110 and 130 is described according to an embodiment, the present invention is not limited thereto. For example, an organic light emitting diode display or a plasma display panel may be manufactured by using the first substrate 110 including the first coating layer 103 for planarization.

In the method of manufacturing the LCD 100 according to one embodiment of the present invention, the first substrate 110 including the first coating layer 103 formed on the first fiber reinforced plastic substrate 101 is prepared, the second substrate 130 facing the first substrate 110 is prepared, and the liquid crystal layer 150 is interposed between the first and second substrates 110 and 130. In order to prepare at least one of the first and second substrates 110 and 130, an insulating substrate is prepared, and the first coating layer 103 including polyamic acid co-polymer is formed on the insulating substrate.

First, at least one of the first and second substrates 110 and 130 is prepared. The above substrate may include a flexible substrate, for example, a fiber reinforced plastic substrate according to the present embodiment.

The first fiber reinforced plastic substrate 101 is prepared by impregnating glass fiber, yarn, or cloth into organic resin such as epoxy resin to make a preliminary substrate, compressing the preliminary substrate using a press plate having a flat surface, and curing the preliminary substrate with heat. The curing and compressing of the preliminary substrate may be performed through a single process.

In this case, the glass fiber may be directly used, or the glass fiber woven in the form of yarn may be used according to an embodiment.

Next, as shown in FIG. 5A, the first coating layer 103 is formed on the first fiber reinforced plastic substrate 101.

The coating layer 103 is formed by coating a coating material including compounds of formulae 1 and 2 on at least one of the first and second substrates 110 and 130 such that the coating material is covered on the front surface and the side surface of at least one of the first and second substrates 110 and 130 and then curing the coating material.

The coating material contains prepolymer including polyesterpolyamic acid co-polymer, epoxy polymer, and an epoxy curing agent and a silane cross-linking agent. The epoxy curing agent and the silane cross-linking agent cure and cross-link the polyesterpolyamic acid prepolymer and the epoxy polymer.

In this case, the coating material includes about 7.5 wt % to about 9 wt % of the polyesterpolyamic acid prepolymer, about 5 wt % to about 18 wt % of the epoxy polymer, about 1 wt % to about 2 wt % of the epoxy curing agent, and 0.1 wt % of the silane cross-linking agent. The present invention is not limited to the above epoxy curing agent and the epoxy polymer. According to another embodiment of the present invention, epoxy curing agent capable of curing or cross-linking the polyesterpolyamic acid prepolymer and the epoxy polymer can be used.

The present invention is not limited to the silane cross-linking agent, but a compound having a structure represented by the following formula 3 can be used according to one embodiment. In this case, X corresponds to one of functional groups of vinyl, epoxy, amino, methacryl, acryl, isocyanato, and mercapto, and R corresponds to one of functional groups of methoxy, ethoxy, and acetoxy.

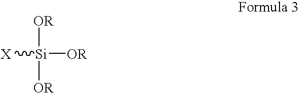

In this case, the coating material may include about 70 wt % or more of methyl-3-methoxypropionate in addition to the above materials. The methyl-3-methoxypropionate may be used as a solvent, and the weight ratio thereof can be adjusted according to an amount of the prepolymer including polyesterpolyamic acid co-polymer, the epoxy polymer, and the epoxy curing agent, or the silane cross-linking agent.

The polyesterpolyamic acid prepolymer may be used as a prepolymer of polyesterpolyamic acid co-polymer, which includes the monomers of formulae 1 and 2 above. The prepolymer has a smaller molecular weight, and can be polymerized to polymer having a greater molecular weight through polymerization reactions.

If necessary, the mixture of the monomers of formulae 1 and 2 may be used instead of the prepolymer. In this case, the monomers of formulae 1 and 2 can be polymerized using a cross-linking agent.

The coating material includes a liquid-phase material having viscosity. A process of coating the coating material on a substrate is not limited to a particular technique, and the coating material may be coated through various methods such as spin coating, slit coating, and ink-jet coating.

The coating material coated on the substrate is cured to provide the first coating layer 103 through a curing process. The coating material is cured at a temperature less than the glass transition temperature of the substrate. For example, the curing process is performed at a temperature of about 180° C. or less. In the present embodiment, when the temperature for the curing process exceeds about 180° C., since the temperature of about 180° C. is higher than a glass transition temperature (Tg) of the first fiber reinforced plastic substrate 101, roughness is increased due to phase transition. Preferably, the curing process is performed at a temperature of about 150° C. This curing process is performed at a very low temperature as compared with a case in which a typical coating material is cured at a temperature of about 200° C. or more. Accordingly, the curing process can be performed at a low temperature as described above, so that a material unsuitable for a substrate at a high temperature can be used for a substrate.

In addition, a typical coating material must be subject to a thermal curing process at a temperature of about 200° C. or more (about 220° C. in the case of glass) after going through a curing process with light rays, such as ultra violet rays. However, the coating material according to an embodiment of the present invention can be subject to the thermal curing process at a temperature of about 150° C. without the curing process with light rays. Accordingly, the manufacturing process can be simplified, so that time and cost for the manufacturing process can be reduced.

Preferably, the above curing process is performed for between about 30 minutes and about three hours. If the curing process is performed for a time shorter than 30 minutes, the coating material may be not sufficiently cured. If the curing process is performed for a time longer than three hours, an excessive time may be spent, so that efficiency may be actually degraded in the manufacturing process.

The first coating layer 103 has a thickness equal to or greater than about 1.4 μm. If a thickness of the first coating layer 103 is thinner than the range, the step difference remains.

When a subsequent process is performed with respect to the substrate without the change of a prepared size, the coating layer is formed on the insulating substrate without a cutting process. However, when the subsequent process is performed with respect to a substrate smaller than a mother substrate, the mother substrate is cut by a predetermined size before the first coating layer 103 is formed on the insulating substrate. The size is not limited, and the mother substrate may be cut in a size of a unit cell of a display substrate.

The mother substrate is cut before a subsequent process is performed since ESD (electrostatic discharge) or arc discharge may occur during the subsequent process. In detail, the ESD or the arc discharge occurs mainly when the first fiber reinforced plastic substrate 101 is provided therein with glass fiber, especially when the glass fiber is exposed out of edges of the first fiber reinforced plastic substrate 101. The exposed portion serves as a protrusion, and the protrusion easily collects charges in subsequent processes such as a deposition process. Thus, if charges are collected, so that voltage difference of a predetermined level or more is made during the process such as the deposition process, the ESD or the arc discharge may occur. Accordingly, the ESD may damage components formed on the substrate, for example causing a metal interconnection to be disconnected from each other.

Therefore, according to the present embodiment, the first coating layer 103 covers the side surface of the first fiber reinforced plastic surface 101 over where the glass fiber is exposed, thereby reducing the ESD or the arc discharge. Since the first coating layer 103 includes organic polymer, the first coating layer 103 corresponds to an insulating material to effectively prevent charges from being collected.

Then, as shown in FIG. 5B, the first blocking layer 114 is formed on the first fiber reinforced plastic substrate 101 having the first coating layer 103 by using silicon nitride (SiNₓ) or silicon oxide (SiN₂), and the gate electrode 113 and the gate line 111 are formed on the first blocking layer 114. In this case, the gate electrode 113 and the gate line 111 may be formed by depositing a first conductive film on the surface of the first substrate 110 and patterning the resulting structure through a photolithography process.

Thereafter, as shown in FIG. 5C, after sequentially depositing the gate insulating layer 115, an amorphous silicon layer and an n+ amorphous silicon layer are deposited on the surface of the first substrate 110 having the gate electrode 113 and the gate line 111, and the amorphous silicon layer 124 and the n+ amorphous silicon layer are selectively patterned through a photolithography process, thereby forming the ohmic-contact layer 119 allowing the source and drain electrodes 121 and 123 (FIG. 5D) to make ohmic-contact with the active layer 117.

Next, as shown in FIG. 5D, after depositing a second conductive film on the surface of the first substrate 110 having the active layer 117 and the ohmic-contact layer 119, the second conductive film is selectively patterned through a photolithography process, thereby forming the source and drain electrodes 121 and 123 including the second conductive film. The source electrode 121 actually corresponds to a portion of the data line 112 (FIG. 1) crossing the gate line 111 to define a pixel area.

Although the active layer 117, the ohmic-contact layer 119, the source electrode 121, and the drain electrode 123 are formed through two photolithography processes, the active layer 117, the ohmic-contact layer 119, the source electrode 121, and the drain electrode 123 may be formed through one photolithography process if a diffraction mask is employed.

Then, as shown in FIG. 5E, after depositing the protective layer 125 on the surface of the first substrate 110 having the source electrode 121 and the drain electrode 123, a portion of the protective layer 125 is removed through a photolithography process, thereby forming the contact hole 129 (FIG. 5F) exposing a portion of the drain electrode 123.

Thereafter, as shown in FIG. 5F, after depositing a transparent conductive material on the surface of the first substrate 110, the resultant structure is selectively patterned through a photolithography process, thereby forming the pixel electrode 127 electrically making contact with the drain electrode 123 through the contact hole 129.

Although a process of preparing the second substrate 130 is not shown in drawings attached hereto, similarly to FIG. 5A and as illustrated in FIG. 2, the second coating layer 133 is formed on the second fiber reinforced plastic substrate 131, thereby preparing the second substrate 130. The second coating layer 133 includes the second blocking layer 135, and the color filer 137 is formed on the block layer 135 through a photolithography process. The common electrode 139 is formed on the color filter 137 using a transparent material.

The first and second substrates 110 and 130 are arranged in opposition to each other and coupled to each other, and the liquid crystal layer 150 is formed between the first and second substrates 110 and 130, thereby manufacturing the LCD 100.

As a result, when a concave-convex substrate such as a fiber reinforced plastic substrate according to the present embodiment is planarized using a coating layer, step differences of the concave-convex substrate is reduced. Accordingly, in subsequent processes, defects caused by the step difference can be significantly reduced.

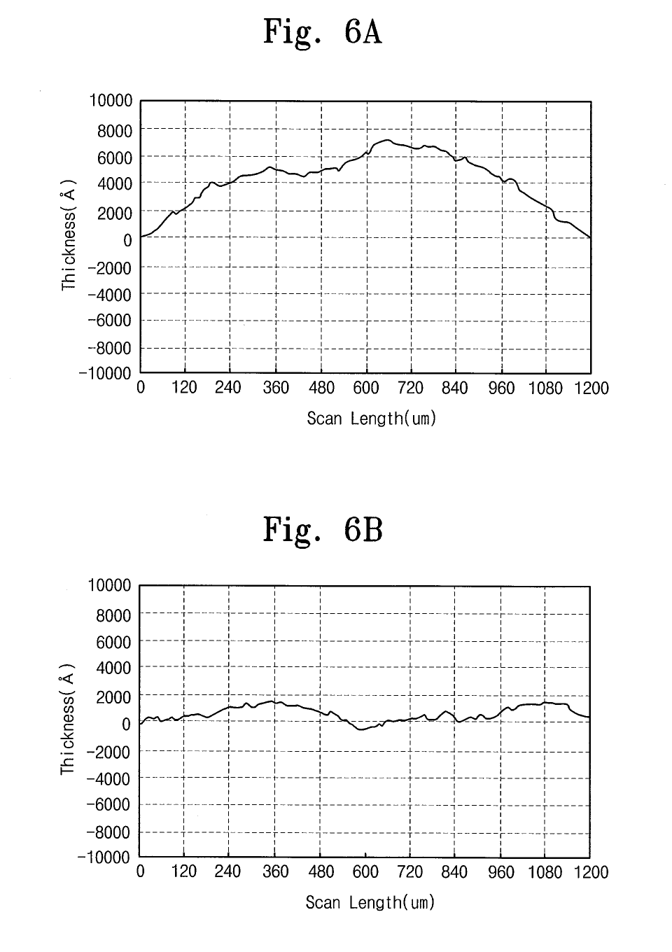

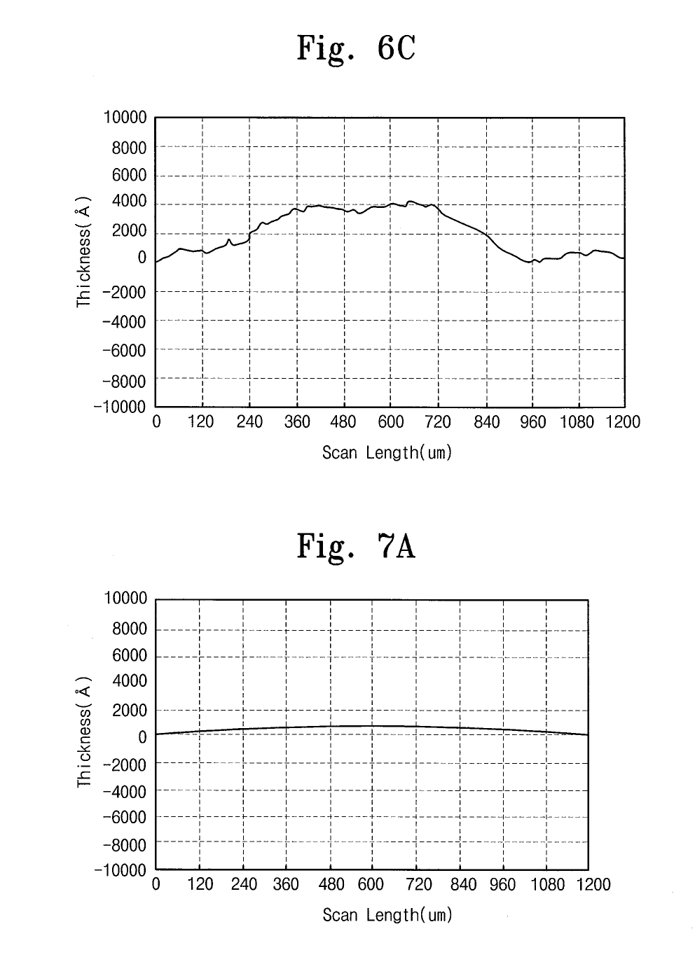

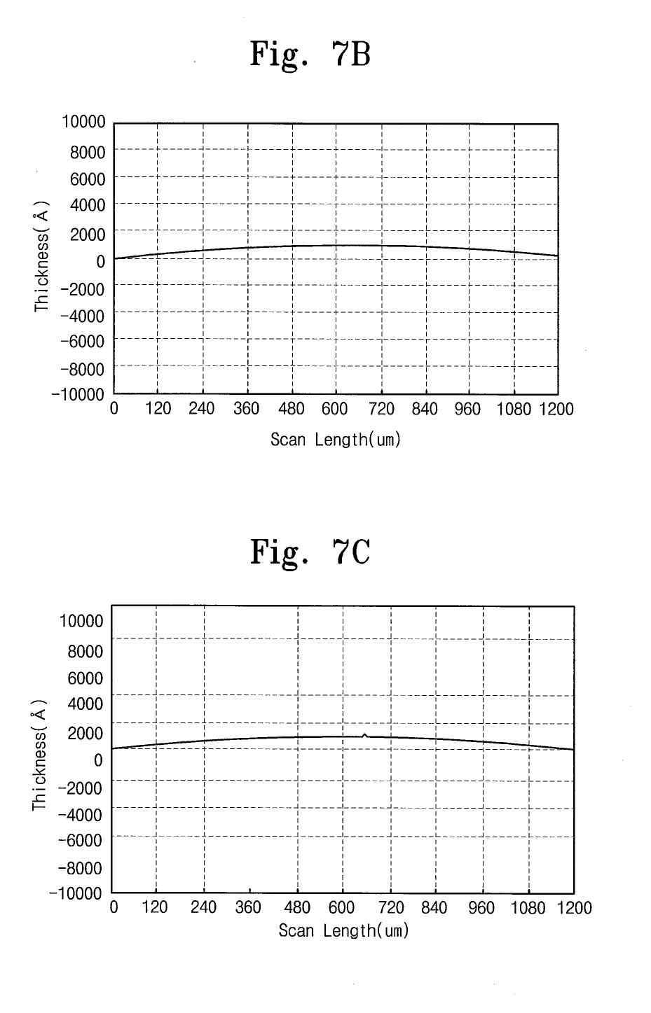

The above effect can be understood from FIGS. 6A to 6C, and FIGS. 7A to 7B. FIGS. 6A to 6C are graphs showing step differences shown in three positions of the surface of a fiber reinforced plastic substrate before a coating layer is formed, and FIGS. 7A to 7B are graphs showing step differences shown in three respective positions of the surface of the fiber reinforced plastic substrate after the coating layer is formed. The three positions represent a central portion, a vertical portion, and a horizontal portion of the fiber reinforced plastic substrate. FIGS. 6A and 7A are graphs observed in the same position, FIGS. 6B and 7B are graphs observed in the same position, and FIGS. 6C and 7C are graphs observed in the same position.

The coating layer was formed to a thickness of 3 μm in an oven at a temperature of about 150° C. for 60 minutes.

Table 1 shows the maximum size of the step difference observed in FIGS. 6A to 6C, and FIGS. 7A to 7C, and the unit of the size is micro-meter (μm).

TABLE 1

| | Central | Horizontal | | Average step |
|---|---|---|---|---|
| | portion | edge | Vertical edge | difference |
| Before coating | 700 | 220 | 440 | 450 |
| After coating | 60 | 90 | 100 | 80 |

Table 1 shows an average step difference of about 450 μm and about 80 μm before and after the coating layer according to an embodiment of the present invention, and the step difference is reduced to about ⅙ after the coating layer according to an embodiment of the present invention. Based on the above values, the coating layer is formed to effectively planarize a concave-convex substrate, for example, a fiber reinforced plastic substrate.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. A method of manufacturing an apparatus, the method comprising:
preparing a substrate;
forming a coating layer comprising polyamic acid co-polymer on the substrate to planarize the substrate; and,
forming a plurality of thin films on the coating layer.

2. The method of claim 1, wherein monomers of the polyamic acid co-polymer comprises monomers represented by the following formulae 1 and 2: 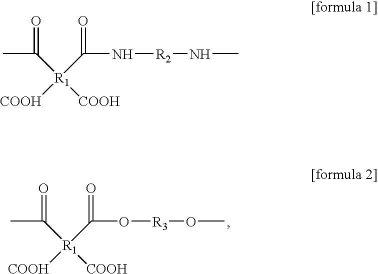
wherein R₁ represents carbon or tetracarboxylic dianhydride, R₂ represents C₁-C₂₀ alkane or diamine, and R₃ represents C₁-C₂₀ alkane or diol.

3. The method of claim 2, wherein the substrate comprises a front surface, a rear surface facing the front surface, and a side surface connecting the front surface to the rear surface, and
the forming of the coating layer comprises:
coating a coating material comprising compounds consisting of the monomers represented in formulae 1 and 2 on at least one of the front surface and the rear surface of the substrate and the side surface; and
curing the coating material.

4. The method of claim 3, wherein the coating material comprises about 7.5 wt % to about 9 wt % of polyesterpolyamic acid prepolymer, about 5 wt % to about 18 wt % of epoxy polymer, about 1 wt % to about 2 wt % of an epoxy curing agent, and about 0.1 wt % of a silane cross-linking agent.

5. The method of claim 4, wherein the coating material comprises methyl-3-methoxypropionate.

6. The method of claim 4, wherein the polyesterpolyamic acid prepolymer forms polyesterpolyamic acid co-polymer through a heating process.

7. The method of claim 3, wherein the coating material is cured at a temperature less than the glass transition temperature of the substrate.

8. The method of claim 3, wherein the coating material is cured at a temperature of about 180° C. or less.

9. The method of claim 8, wherein the coating material is cured for about 30 minutes to about three hours.

10. The method of claim 3, wherein the coating layer has a thickness equal to or greater than about 1.4 μm.

11. The method of claim 1, further comprising preparing a counter substrate to face the substrate and forming a liquid crystal layer between the substrate and the counter substrate.

12. An apparatus, comprising:
a substrate comprising a plurality of pixels; and
a coating layer on the substrate, the coating layer comprising polyamic acid co-polymer.

13. The apparatus of claim 12, wherein monomers of the polyamic acid co-polymer are represented by the following formulae 1 and 2: 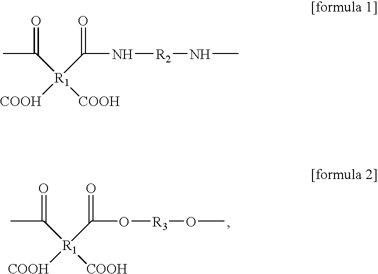
wherein R₁ represents carbon or tetracarboxylic dianhydride, R₂ represents C₁-C₂₀ alkane or diamine, and R₃ represents C₁-C₂₀ alkane or diol.

14. The apparatus of claim 13, wherein the coating layer comprises about 7.5 wt % to about 9 wt % of the polyamic acid co-polymer and the polyamic acid co-polymer is one of alternating co-polymer, periodic co-polymer, random co-polymer, and block co-polymer.

15. The apparatus of claim 13, wherein the coating layer has a thickness equal to or greater than about 1.4 μm.

16. The apparatus of claim 13, wherein the substrate comprises a fiber reinforced plastic substrate.

17. The apparatus of claim 13, further comprising a plurality of thin films formed on the coating layer.

18. The apparatus of claim 13, further comprising a counter substrate facing to the substrate and a liquid crystal layer formed between the substrate and the counter substrate.

19. A method of manufacturing a display apparatus, the method comprising:
preparing a first substrate;
preparing a second substrate;
coating a coating material comprising polyamic acid co-polymer on at least one of the first and second substrates;
curing the coating material at a temperature of about 180° C. or less to form a coating layer planarizing the at least one of the first and second substrates;
forming a plurality of thin films on the coating layer; and
coupling the first substrate to the second substrate,
wherein the polyamic acid co-polymer comprises monomers represented by the following formulae 1 and 2: 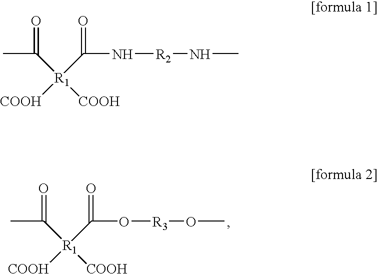
wherein R₁ represents carbon or tetracarboxylic dianhydride, R₂ represents C₁-C₂₀ alkane or diamine, and R₃ represents C₁-C₂₀ alkane or diol.

20. The method of claim 19, wherein the coating material is cured for about 30 minutes to about three hours.
